(19) United States
(12) Patent Application Publication
(10) Pub. No.: US 2024/0054414 A1
(43) Pub. Date: Feb. 15, 2024

(54) CREATING A WORKFLOW BASED ON DATA ENTERED INTO DIGITAL FORM

(71) Applicant: SWARUP RAMAPRIYA MAVANOOR, BENGALURU (IN)

(72) Inventor: SWARUP RAMAPRIYA MAVANOOR, BENGALURU (IN)

(21) Appl. No.: 18/097,674

(22) Filed: Jan. 17, 2023

Related U.S. Application Data
(63) Continuation-in-part of application No. 17/541,051, filed on Dec. 2, 2021.

(51) Int. Cl. G06Q 10/0631; G06F 40/174

(52) U.S. Cl. CPC G06Q 10/0631; G06F 40/174

(57) ABSTRACT

In one aspect, a computerized method includes the step of creating a workflow based on data entered into a digital form; associating a set of actions, tasks and forms to a physical component or a logical component in a system hierarchy based on an action; traversing a system hierarchy tree of the system hierarchy; and associating an action with a parent/child component of the system hierarchy tree based on a data from the physical component or the logical component.

### CLAIM OF PRIORITY

This application claims priority to U.S. Provisional Application No. 63/290,646, and filed on Dec. 16, 2021, and titled CREATING A WORKFLOW BASED ON DATA ENTERED INTO FORM OR CHECKLIST AND OTHER METHODS. This provisional application is hereby incorporated by reference in its entirety.

This application claims priority to and is a continuation in part of U.S. patent application Ser. No. 17/541,051, filed on Dec. 2, 2021, and titled METHODS AND SYSTEMS OF OPERATIONS AND MAINTENANCE OF A PHYSICAL ASSETS. This utility application is hereby incorporated by reference in its entirety.

### BACKGROUND

Solar power plant operations management is one of the least digitized globally. Solar operations still often rely on traditional methodologies. Potential operations and maintenance cost savings can be realized through digitalization of various manually performed tasks. Digital transformation of operations and maintenance (e.g. including thermography) can improve yield gains while significantly reducing the time required for such manual inspections. Digital transformation of operations and maintenance can also enable/enhance collaboration for internal and external teams. Scheduling and execution of preventive and corrective maintenance can be streamlined, enabling timely identification and rectification of issues that cause yield loss.

### SUMMARY OF THE INVENTION

In one aspect, a computerized method includes the step of creating a workflow based on data entered into a digital form; associating a set of actions, tasks and forms to a physical component or a logical component in a system hierarchy based on an action; traversing a system hierarchy tree of the system hierarchy; and associating an action with a parent/child component of the system hierarchy tree based on a data from the physical component or the logical component.

### BRIEF DESCRIPTION OF THE DRAWINGS

The present application can be best understood with reference to the following description taken in conjunction with the accompanying figures, in which like parts may be referred to by like numerals.

FIG. 1 illustrates an example process, according to some embodiments.

FIG. 2 illustrates an example process for creating a workflow based on data entered into form or checklist, according to some embodiments.

FIG. 3 illustrates an example process for triggering additional actions based on the test/check conditions defined in the form and values input by a user to a form instance, according to some embodiments.

FIG. 4 illustrates an example process that provides the ability to traverse a system hierarchy tree and associate actions with parent/child components, according to some embodiments.

FIG. 5 illustrates an example process, according to some embodiments.

FIG. 6 depicts an exemplary computing system that can be configured to perform any one of the processes provided herein.

The Figures described above are a representative set and are not exhaustive with respect to embodying the invention.

### DESCRIPTION

Disclosed are examples systems, methods, and articles or manufacture of a workflow based on data entered into a digital form or checklist. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Example Definitions

A tree structure is a way of representing the hierarchical nature of a structure in a graphical form. It is named a tree structure because the classic representation resembles a tree, although the chart is generally upside down compared to a biological tree, with the stem at the top and the leaves at the bottom. A node's parent is a node one step higher in the hierarchy (e.g. closer to the root node) and lying on the same branch. A sibling node shares the same parent node. A node's uncles are siblings of that node's parent. A node that is connected to all lower-level nodes is called an ancestor. The connected lower-level nodes are descendants of the ancestor node.

### Exemplary Methods

An electronic system is provided that includes a method to create/define digital forms equivalent to paper forms with one or more fields of different input types (e.g. numeric, alphanumeric, dropdown, radio button, checkbox, date, time, image, file, signature, etc.).

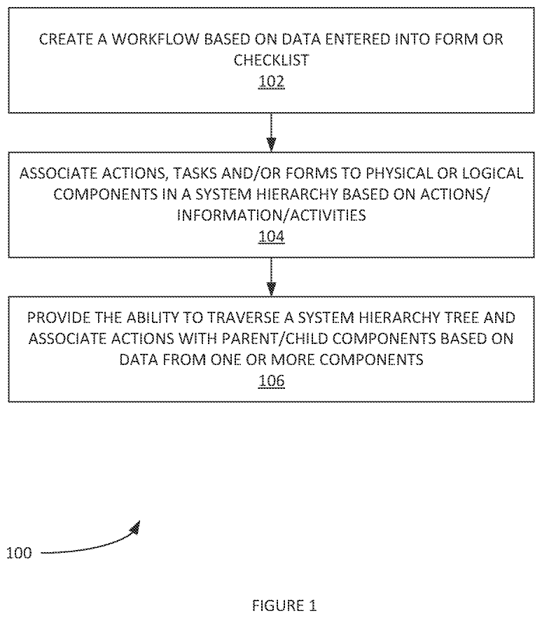

FIG. 1 illustrates an example process 100, according to some embodiments. In step 102, process 100 can create a workflow based on data entered into form or checklist. In step 104, process 100 can associate actions, tasks and/or forms to physical or logical components in a system hierarchy based on actions/information/activities. In step 106, process 100 provide the ability to traverse a system hierarchy tree and associate actions with parent/child components based on data from one or more components.

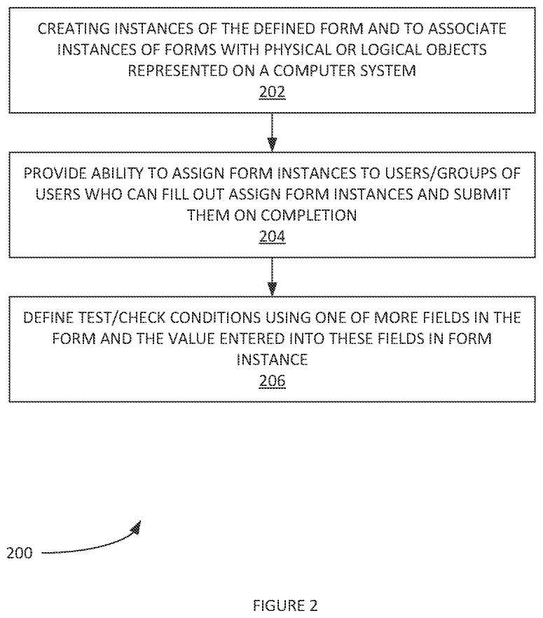

FIG. 2 illustrates an example process 200 for creating a workflow based on data entered into form or checklist, according to some embodiments. In step 202, process 200 can creating instances of the defined form and to associate instances of forms with physical or logical objects represented on a computer system. In step 204, process 200 can provide the ability to assign form instances to users/groups of users who can fill out assign form instances and submit them on completion. In step 206, process 200 can, for each form, to define test/check conditions using one of more fields in the form and the value entered into these fields in a form instance.

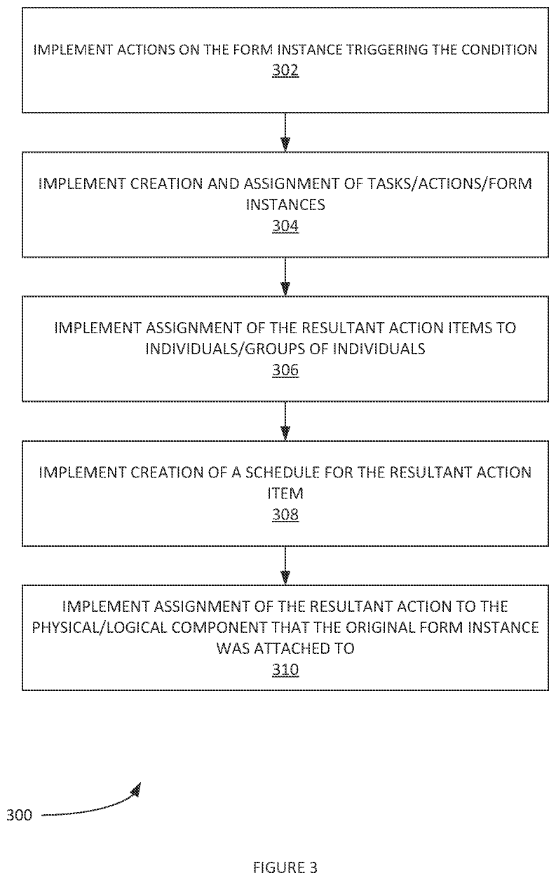

FIG. 3 illustrates an example process 300 for triggering additional actions based on the test/check conditions defined in the form and values input by a user to a form instance, according to some embodiments. In step 302, process 300 can implement actions on the form instance triggering the condition. In step 304, process 300 can implement creation and assignment of tasks/actions/form instances. In step 306, process 300 can implement assignment of the resultant action items to individuals/groups of individuals. In step 308, process 300 can implement creation of a schedule for the resultant action item. In step 310, process 300 can implement assignment of the resultant action to the physical/logical component that the original form instance was attached to.

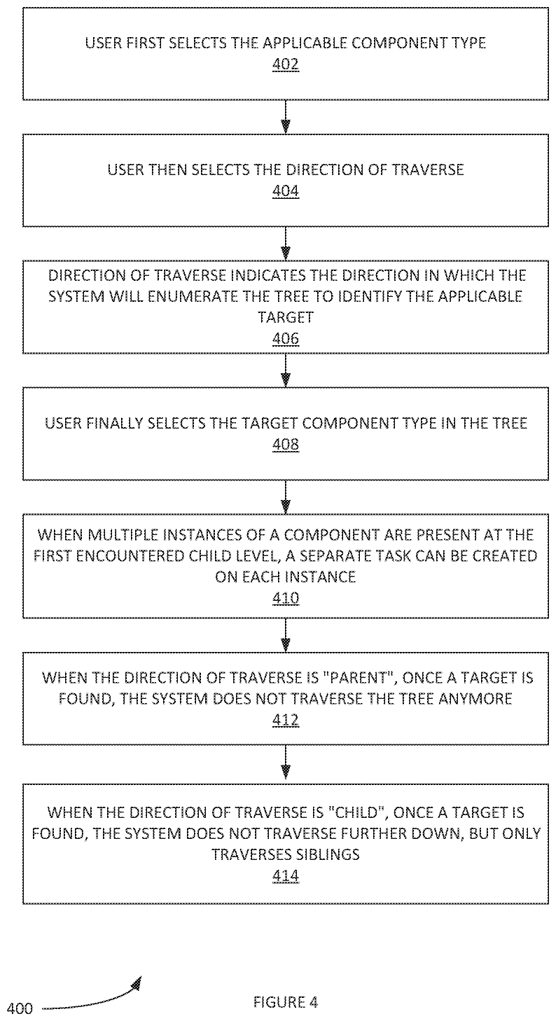

FIG. 4 illustrates an example process 400 that provides the ability to traverse a system hierarchy tree and associate actions with parent/child components, according to some embodiments. In step 402, the user first selects the applicable component type. This field ensures that this workflow will execute only if the form is attached to a specific component type and will not result in any action if the form is attached to a component other than one that is specified.

In step 404, the user then selects the direction of traverse (e.g. child or parent). In step 406, the direction of traverse indicates the direction in which the system will enumerate the tree to identify the applicable target.

In step 408 the user finally selects the target component type in the tree. This can specify the type of component in the defined direction to which the task will be linked.

In step 410, if multiple instances of a component are present at the first encountered child level, a separate task will be created on each instance.

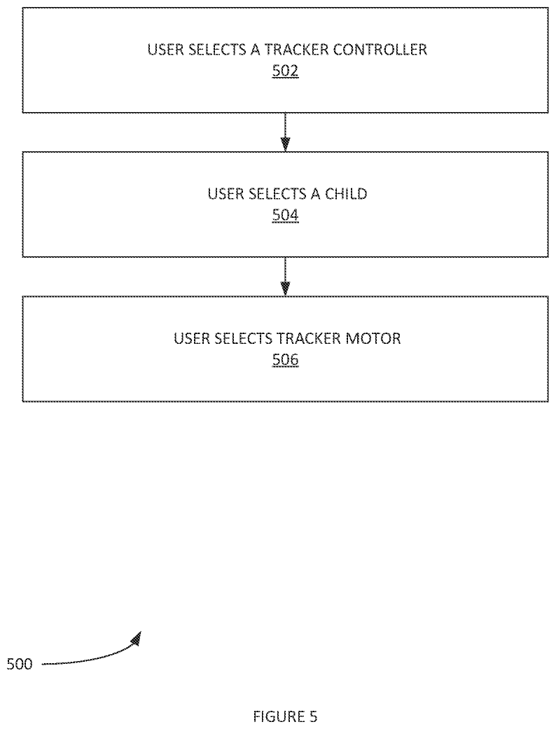

FIG. 5 illustrates an example process 500, according to some embodiments. For example, a form is attached to a tracker controller and based on a measured value, process 100 can be used to create a task attached to every tracker motor downstream. In this case, the user selects a tracker controller in step 502. The user selects a child in the step 504 (e.g. direction of traverse). The user selects tracker motor in step 506. In this case, when the workflow is triggered, a task is created for each motor downstream.

Returning to process 400, in step 412, process 400 can, when the direction of traverse is parent, once a target is found, the system does not traverse the tree anymore.

In step 414, process 400 can, when the direction of traverse is “child” once a target is found, the system does not traverse further down, but only traverses siblings to identify other instances of the same component type at the same level.

### Additional Example Computer Architecture and Systems

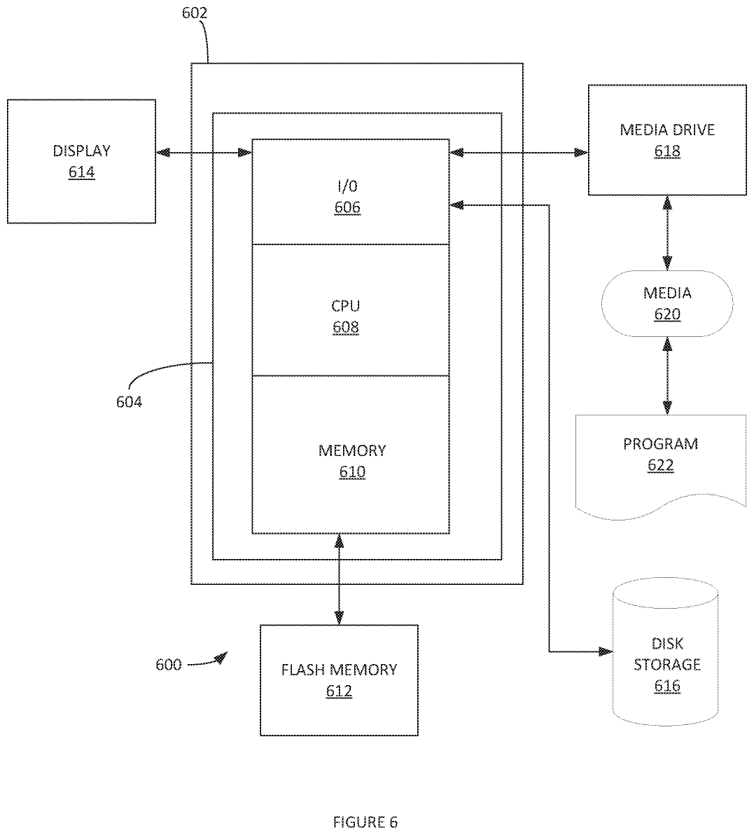

FIG. 6 depicts an exemplary computing system 600 that can be configured to perform any one of the processes provided herein. In this context, computing system 600 may include, for example, a processor, memory, storage, and I/O devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform any of the processes described herein. The main system 602 includes a motherboard 604 having an I/O section 606, one or more central processing units (CPU) 608, and a memory section 610, which may have a flash memory card 612 related to it. The I/O section 606 can be connected to a display 614, a keyboard and/or other user input (not shown), a disk storage unit 616, and a media drive unit 618. The media drive unit 618 can read/write a computer-readable medium 620, which can contain programs 622 and/or data. Computing system 600 can include a web browser. Moreover, it is noted that computing system 600 can be configured to include additional systems in order to fulfill various functionalities. Computing system 600 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A computerized method comprising:
creating a workflow based on data entered into a digital form;
associating a set of actions, tasks and forms to a physical component or a logical component in a system hierarchy based on an action;
traversing a system hierarchy tree of the system hierarchy; and
associating an action with a parent/child component of the system hierarchy tree based on a data from the physical component or the logical component.

2. The computerized method of claim 1, wherein the step of creating the workflow based on the data entered into the digital form comprises:
creating a form instance of the digital form; and
associating the form instance of the digital form with a physical object or a logical object represented on a computer system.

3. The computerized method of claim 1, wherein the step of creating the workflow based on the data entered into the digital form comprises:
assigning the form instance to a user; and
submitting the form instance upon completion.

4. The computerized method of claim 3, wherein the step of creating the workflow based on the data entered into the digital form comprises:
defining a test condition using one of more fields in the digital form and the value entered into these fields in the form instance.

5. The computerized method of claim 4, wherein the form instance is assigned to a group of users.

6. The computerized method of claim 5, wherein the digital form comprises a checklist.

7. The computerized method of claim 6, wherein the step of associating the set of actions, tasks and forms to the physical component or the logical component in the system hierarchy based on the action comprises:
implementing the action on the form instance and triggering the test condition; and
implementing creation and assignment of tasks/actions/form instances.

8. The computerized method of claim 7, wherein the step of associating the set of actions, tasks and forms to the physical component or the logical component in the system hierarchy based on the action comprises:
implementing an assignment of a resultant action item to a specified group.

9. The computerized method of claim 8, wherein the step of associating the set of actions, tasks and forms to the physical component or the logical component in the system hierarchy based on the action comprises:
implementing a creation of a schedule for the resultant action item.

10. The computerized method of claim 9, wherein the step of associating the set of actions, tasks and forms to the physical component or the logical component in the system hierarchy based on the action comprises:
implementing an assignment of the resultant action to the physical component and the logical component that an original form instance was attached to.

11. The computerized method of claim 10, wherein the step of associating the action with the parent/child component of the system hierarchy tree based on the data from the physical component or the logical component comprises:
detecting that the user first selects the applicable component type; and
detecting that the user selects a direction of traverse.

12. The computerized method of claim 11, wherein a direction of traverse indicates a direction in which the hierarchal system enumerates the tree structure to identify an applicable target.

13. The computerized method of claim 12, wherein the step of associating the action with the parent/child component of the system hierarchy tree based on the data from the physical component or the logical component comprises:
detecting that the user selects the target component type in the hierarchy tree.

14. The computerized method of claim 13, wherein when a plurality of instances of a component are present at a first encountered child level of the hierarchy tree, a separate task is created on each form instance.

15. The computerized method of claim 14, wherein when the direction of traverse is to a parent, once a target node is found, the hierarchal system ceases to traverse the hierarchical tree.

16. The computerized method of claim 15, wherein when the direction of traverse is to a child node, once a target node is found, the hierarchical system does not traverse further down the hierarchal tree, but only traverses the set of sibling nodes.

17. The computerized method of claim 16, wherein a digital form is attached to a tracker controller and based on a measured value, and wherein a task is attached to every tracker motor downstream.

18. The computerized method of claim 1, wherein the system hierarchy is based on an action, an information, and an activity.
